(19) United States
(12) Patent Application Publication
(10) Pub. No.: US 2016/0372862 A1
(43) Pub. Date: Dec. 22, 2016

(54) DOUBLE LOCKING DEVICE FOR CHARGER

(71) Applicants: Hyundai Motor Company, Seoul (KR); Kia Motors Corporation, Seoul (KR)

(72) Inventors: Jeong Han KIM, Hwaseong-si (KR); Jung Dae Kim, Hwaseong-si (KR)

(73) Assignees: Hyundai Motor Company, Seoul (KR); Kia Motors Corporation, Seoul (KR)

(21) Appl. No.: 14/886,729

(22) Filed: Oct. 19, 2015

(30) Foreign Application Priority Data
Jun. 16, 2015 (KR) 10-2015-0085362

(51) Int. Cl. H01R 13/627

(52) U.S. Cl. CPC H01R 13/6271

(57) ABSTRACT

A double locking device for a charger may include a charging connector mounted to an end of a charging cable to transmit electricity to a charging inlet by being connected with the charging inlet, a latch mounted to the charging connector and configured to be locked with a locking end formed at the charging inlet so the charging connector cannot be pulled out and be lifted such that the charging connector can be pulled out, when the charging inlet and the charging connector are connected, a stopper configured to be moved forward over the latch by an actuator so the latch cannot be lifted or is moved backward by the actuator such that the latch can be lifted, and an inlet cover covering the charging inlet to protect the charging inlet after the charging connector is pulled out.

### CROSS-REFERENCE TO RELATED APPLICATION

The present application claims priority to Korean Patent Application Number 10-2015-0085362 filed Jun. 16, 2015, the entire contents of which is incorporated herein for all purposes by this reference.

### BACKGROUND OF THE INVENTION

Field of the Invention

The present invention relates to a locking device, and, more particularly, to a double locking device for a charger, the double locking device locking each of a charging connector and an inlet cover.

Description of Related Art

In general, an electric vehicle is equipped with a charging inlet for charging a battery, the charging inlet is mainly mounted at a side of an electric vehicle, and a charging inlet cover or a charging door which is similar to a prior opening and closing door of an oil filling port is now being used.

FIG. 1 is a front view of a prior art (related art) charging inlet.

A charging connector mounted at an end of a charging cable is connected with a charging inlet 100, and thereby a battery is charged.

A locking device of a charging connector is needed for the charging connector to be prevented from being pulled out while a battery is charged.

Further, after the charging is completed, an inlet cover or a charging door needs closing and locking. Otherwise, an unexpected exposure of a charging inlet, inside damage thereof, or inflow of foreign matters may happen.

Referring to FIG. 1, a charging connector locking actuator and an inlet cover locking actuator are separately configured in a prior art locking device.

Because a prior art locking device needs two actuators, assembly processes become complicated, cost and weight increase, and a charging inlet device occupies relatively large space.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a double locking device for a charger, which achieves charging connector locking function and inlet cover (or charging door) locking function with only a single actuator, thereby reducing cost and weight, simplifying assembly processes, and saving mounting space of a charging inlet device.

According to various aspects of the present invention, a double locking device for a charger may include a charging connector mounted to an end of a charging cable to transmit electricity to a charging inlet by being connected with the charging inlet, a latch mounted to the charging connector and configured to be locked with a locking end formed at the charging inlet so the charging connector cannot be pulled out and be lifted such that the charging connector can be pulled out, when the charging inlet and the charging connector are connected, a stopper configured to be moved forward over the latch by an actuator so the latch cannot be lifted or is moved backward by the actuator such that the latch can be lifted, and an inlet cover covering the charging inlet to protect the charging inlet after the charging connector is pulled out, in which the inlet cover may be configured to be locked by moving forward of the stopper.

The moving forward and the moving backward of the stopper may be respectively performed over a predetermined distance.

The stopper may include a locking groove, the inlet cover may include a cover lock which is locked with the locking groove, and the cover lock may be configured to be locked with the locking groove by moving forward of the stopper.

A hook may be formed at an end of the cover lock, and the hook may be inserted into the locking groove.

The stopper may include a protruding hook protruding in a direction of the moving forward of the stopper, the inlet cover may include a fixing lock having a fixing groove formed at a side thereof, and the protruding hook may be configured to be inserted into the fixing groove by the moving forward of the stopper.

The double locking device may further include a charging door covering and closing a portion where the inlet cover and the charging inlet are disposed, in which the stopper may include a locking groove, the charging door may include a cover lock which is locked with the locking groove, and the cover lock may be configured to be locked with the locking groove by moving forward of the stopper.

The double locking device may further include a charging door covering and closing a portion where the inlet cover and the charging inlet are disposed, in which the stopper may include a protruding hook protruding in a moving direction of the stopper, the charging door may include a fixing lock having a fixing groove formed at a side thereof, and the protruding hook may be configured to be locked with the fixing groove by the moving forward of the stopper.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view of a prior art (related art) charging inlet.

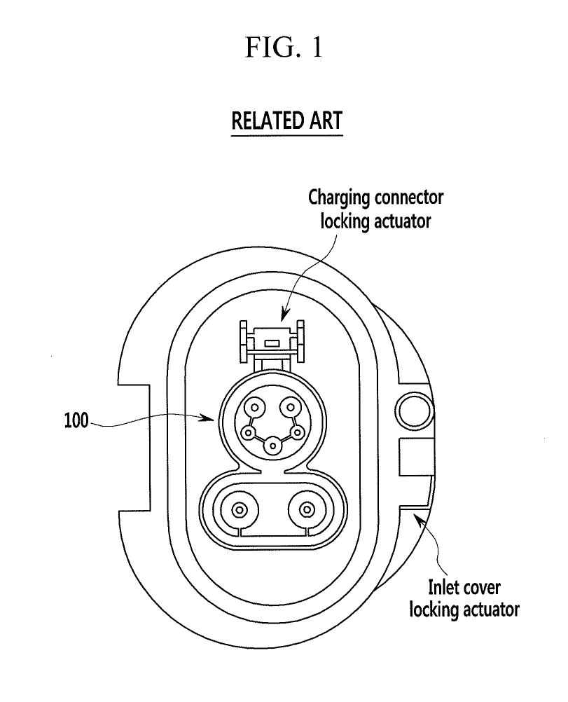

FIG. 2 is a perspective view illustrating an appearance of an exemplary double locking device according to the present invention, while charging.

FIG. 3 is a top plan view illustrating an appearance in which locking of an exemplary double locking device according to the present invention is being released while charging.

FIG. 4 is a top plan view illustrating an appearance in which an exemplary double locking device according to the present invention is being locked for charging.

FIG. 5 is a perspective view illustrating an appearance in which an inlet cover of an exemplary double locking device according to the present invention is locked.

FIG. 6 is a top plan view illustrating an appearance in which an inlet cover of an exemplary double locking device according to the present invention is closed and not locked.

FIG. 7 is a top plan view illustrating an appearance in which an inlet cover of an exemplary double locking device according to the present invention is closed and locked.

FIG. 8 is a top plan view illustrating an appearance in which an inlet cover of an exemplary double locking device according to the present invention is closed and locked.

FIG. 9 is a perspective view illustrating an exemplary double locking device according to the present invention.

FIG. 10 is a perspective view illustrating an exemplary double locking device according to the present invention.

FIG. 11 is a perspective view illustrating an exemplary double locking device according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

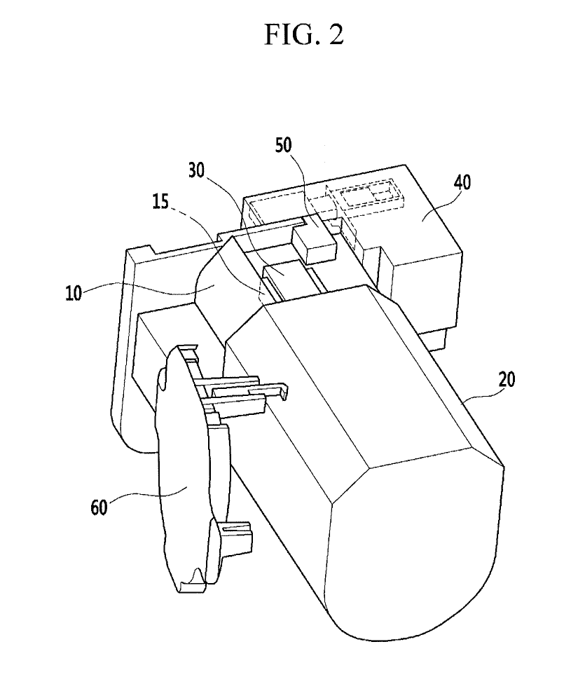

FIG. 2 is a perspective view illustrating an appearance of a double locking device according to various embodiments the present invention, while charging.

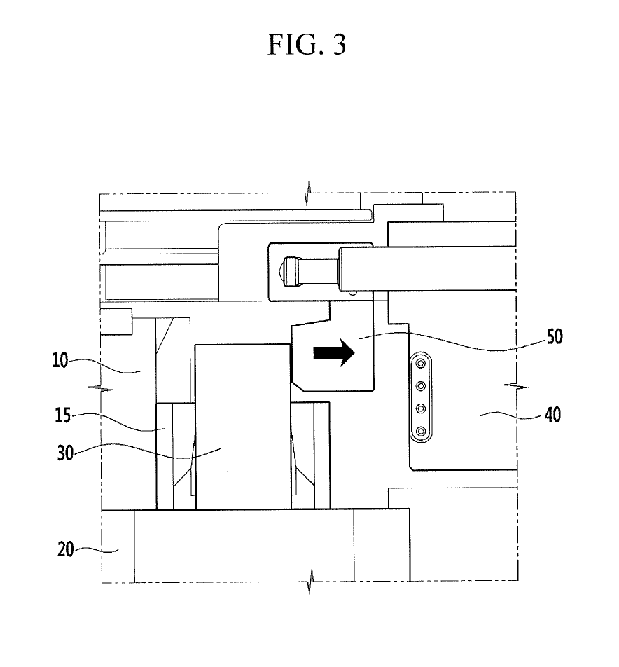

FIG. 3 is a top plan view illustrating an appearance in which locking of a double locking device according to various embodiments of the present invention is being released while charging.

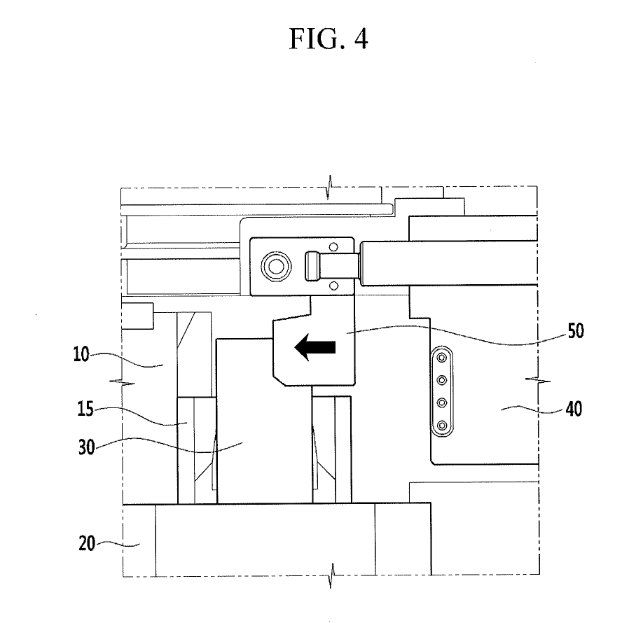

FIG. 4 is a top plan view illustrating an appearance in which a double locking device according to various embodiments of the present invention is being locked for charging.

Referring to FIG. 2, FIG. 3, and FIG. 4, a double locking device for a charger according to various embodiments of the present invention may include a charging connector 20 mounted at an end of a charging cable in order to transmit electricity to a charging inlet 10 by being connected with the charging inlet 10, a latch 30 mounted at the charging connector 20 and configured to be locked with a locking end 15 formed at the charging inlet 10 such that the charging connector 20 cannot be pulled out and be lifted such that the charging connector 20 can be pulled out, when the charging inlet 10 and the charging connector 20 are connected, a stopper 50 which is moved forward over the latch 30 by an actuator 40 such that the latch 30 cannot be lifted or is moved backward by the actuator 40 such that the latch 30 can be lifted, and an inlet cover 60 covering the charging inlet 10 to protect the charging inlet 10 after the charging connector 20 is pulled out.

Referring to FIG. 2, the latch 30 is a locking device which engages when the charging connector 20 is inserted in the charging inlet 10 and which is configured such that the charging connector 20 cannot be pulled out in an opposite direction. In general, the engaging is released when an end portion thereof locked with the locking end 15 is lifted.

Accordingly, the charging connector 20 becomes able to be pulled out from the charging inlet 10.

Detailed explanation will be omitted because the latch 30 is a standard locking device well known to a skilled person in the art.

The actuator 40 is for moving the stopper 50 forward and backward and may comprise a solenoid.

However, the various embodiments of the present invention are not limited to doing so using a solenoid.

That is to say, any type of actuator may be used if there is only an actuator.

In addition, an inlet cover 60 according to various embodiments of the present invention may be locked by moving forward of the stopper 50.

Therefore, a charging connector 20 is locked while charging and an inlet cover 60 is locked after charging is completed, by a single actuator 40 actuating the stopper 50 according to various embodiments of the present invention.

As illustrated in FIG. 3 and FIG. 4, the moving forward and the moving backward of the stopper 50 may be respectively performed as much as a predetermined distance.

That is, FIG. 4 illustrates the moving forward of the stopper 50 to a predetermined position, and FIG. 3 illustrates the moving backward of the stopper 50 to a predetermined position.

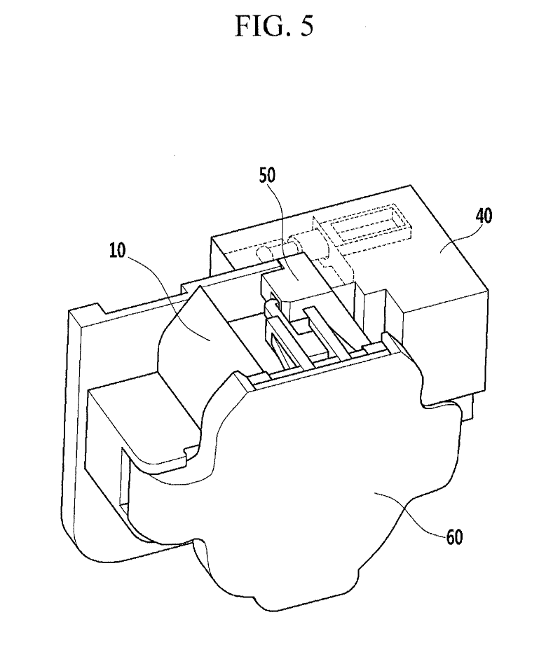

FIG. 5 is a perspective view illustrating an appearance in which an inlet cover of a double locking device according to various embodiments of the present invention is locked.

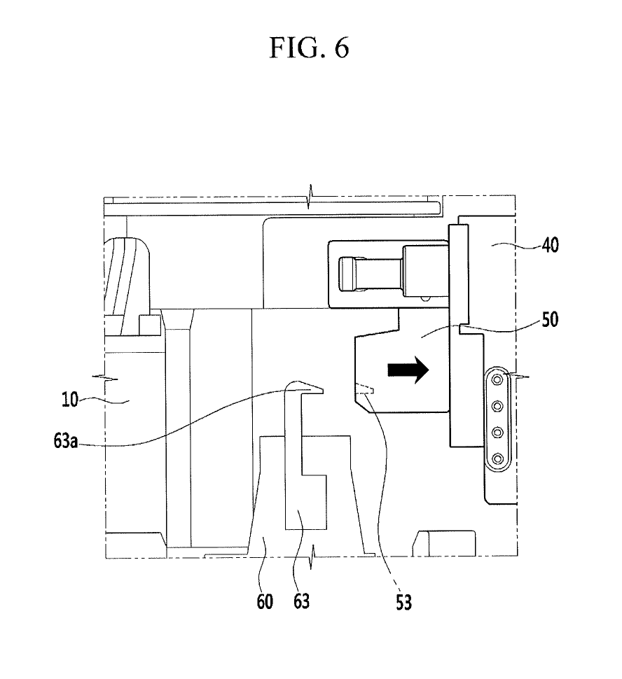

FIG. 6 is a top plan view illustrating an appearance in which an inlet cover of a double locking device according to various embodiments of the present invention is closed and not locked.

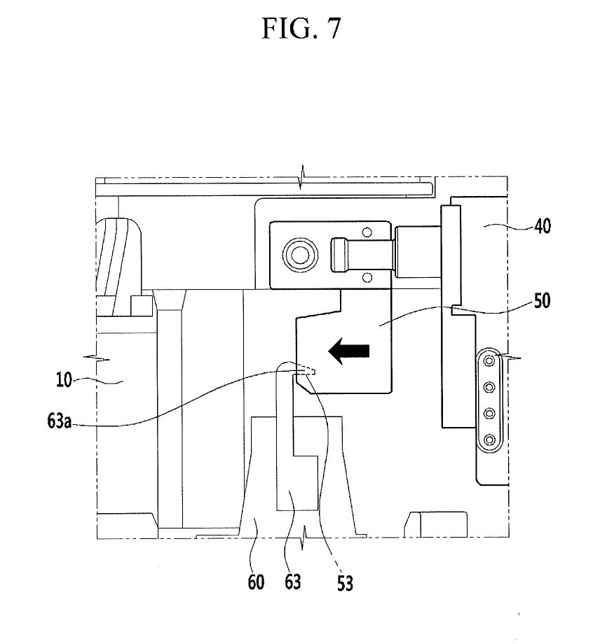

FIG. 7 is a top plan view illustrating an appearance in which an inlet cover of a double locking device according to various embodiments of the present invention is closed and locked.

Referring to FIG. 5, FIG. 6 and FIG. 7, according to double locking devices of various embodiments of the present invention, the stopper 50 may include a locking groove 53, the inlet cover 60 may include a cover lock 63 which is locked with the locking groove 53, and the cover lock 63 may be locked with the locking groove 53 by moving forward of the stopper 50.

As illustrated in FIG. 6 and FIG. 7, the moving forward and the moving backward of the stopper 50 may be respectively performed as much as the predetermined distance as shown in FIG. 3 and FIG. 4.

FIG. 7 illustrates the moving forward of the stopper 50 to a predetermined position and FIG. 6 illustrates the moving backward of the stopper 50 to a predetermined position.

Further, a hook 63a may be formed at an end of the cover lock 63, and the hook 63a may be inserted into the locking groove 53 such that the cover lock 63 is locked.

As a result, the inlet cover 60 is locked.

An exemplary embodiment of FIG. 7 illustrates the above mentioned configuration.

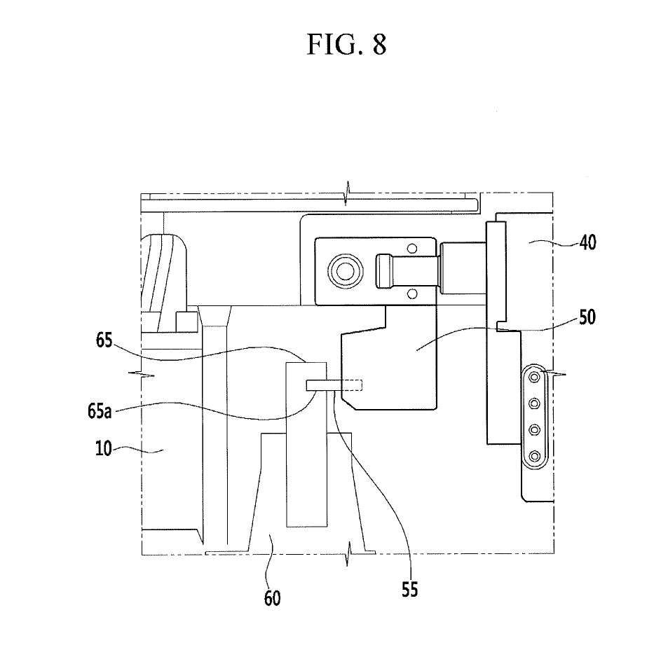

FIG. 8 is a top plan view illustrating an appearance in which an inlet cover of a double locking device according to various embodiments of the present invention is closed and locked.

Referring to FIG. 8, according to double locking devices of various embodiments of the present invention, the stopper 50 may include a protruding hook 55 protruding in a direction of the moving forward of the stopper 50, the inlet cover 60 may include a fixing lock 65 having a fixing groove 65a formed at a side thereof, and the protruding hook 55 may be inserted into the fixing groove 65a by the moving forward of the stopper 50.

Thereby, the inlet cover 60 is locked.

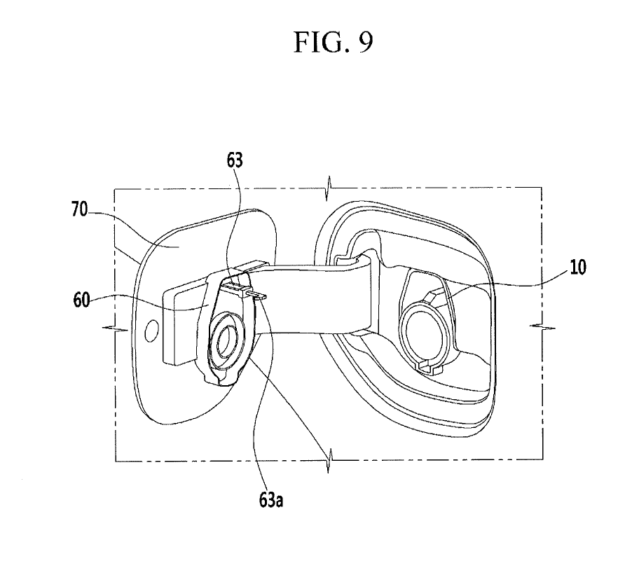

FIG. 9 is a perspective view illustrating a double locking device according to various embodiments of the present invention.

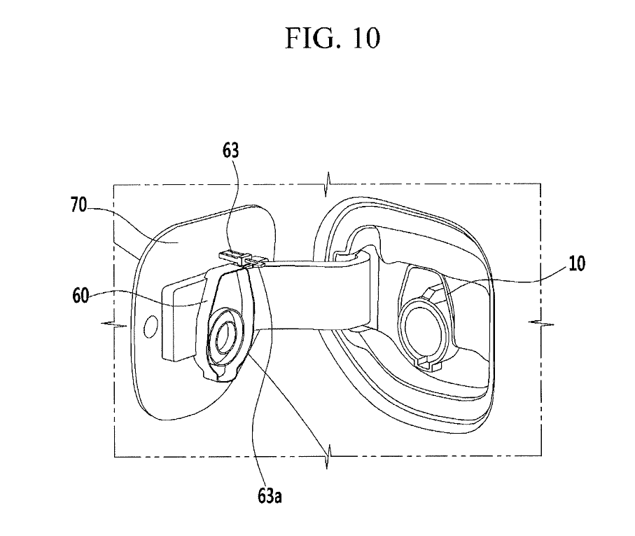

FIG. 10 is a perspective view illustrating a double locking device according to various embodiments of the present invention.

Referring to FIG. 9, the double locking device may further include a charging door 70 covering and closing a portion where the inlet cover 60 and the charging inlet 10 are disposed.

In FIG. 9, a case in which the cover lock 63 is formed at the inlet cover 60 is illustrated as explained before, but the various embodiments of the present invention are not limited thereto, and the cover lock 63 may be mounted at the charging door 70 as shown in FIG. 10. This is well known to a skilled person in the art and detailed description will be omitted.

According to various embodiments where the fixing lock 65 is used instead of the cover lock 63, the fixing lock 65 may be mounted at a position of the cover lock 63 illustrated in FIG. 9 and FIG. 10.

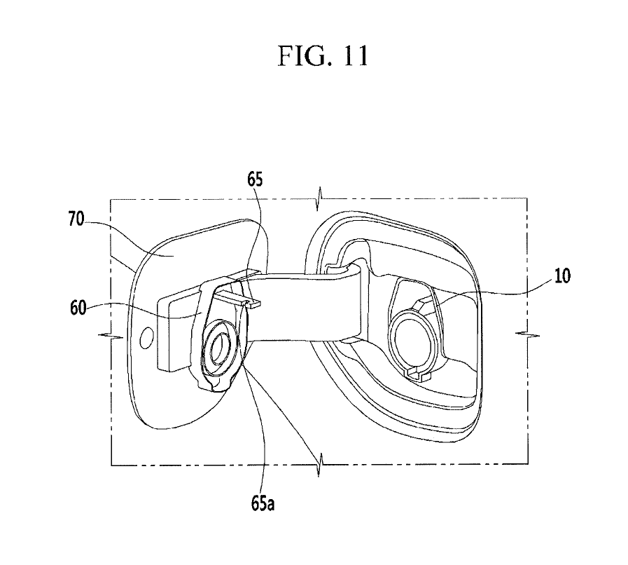

FIG. 11 is a perspective view illustrating another exemplary double locking device according to the present invention, and a case in which the fixing lock 65 is formed at the inlet cover 60 is illustrated.

Further, it is obvious that the fixing lock 65 may be mounted at the charging door 70.

As explained above in detail, charging connector locking function and inlet cover (or charging door) locking function are achieved with only a single actuator, according to the present invention, and thereby cost and weight of locking devices are reduced, assembly processes are simplified, and mounting space is saved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A double locking device for a charger, comprising:
a charging connector mounted to an end of a charging cable to transmit electricity to a charging inlet by being connected with the charging inlet;
a latch mounted to the charging connector and configured to be locked with a locking end formed at the charging inlet so the charging connector cannot be pulled out and be lifted such that the charging connector can be pulled out, when the charging inlet and the charging connector are connected;
a stopper configured to be moved forward over the latch by an actuator so the latch cannot be lifted or is moved backward by the actuator such that the latch can be lifted; and
an inlet cover covering the charging inlet to protect the charging inlet after the charging connector is pulled out,
wherein the inlet cover is configured to be locked by moving forward of the stopper.

2. The double locking device of claim 1, wherein the moving forward and the moving backward of the stopper are respectively performed over a predetermined distance.

3. The double locking device of claim 1, wherein:
the stopper includes a locking groove,
the inlet cover includes a cover lock which is locked with the locking groove, and
the cover lock is configured to be locked with the locking groove by moving forward of the stopper.

4. The double locking device of claim 3, wherein a hook is formed at an end of the cover lock, and the hook is inserted into the locking groove.

5. The double locking device of claim 1, wherein:
the stopper includes a protruding hook protruding in a direction of the moving forward of the stopper,
the inlet cover includes a fixing lock having a fixing groove formed at a side thereof, and
the protruding hook is configured to be inserted into the fixing groove by the moving forward of the stopper.

6. The double locking device of claim 1, further including:
a charging door covering and closing a portion where the inlet cover and the charging inlet are disposed, wherein:
the stopper includes a locking groove,
the charging door includes a cover lock which is locked with the locking groove, and
the cover lock is configured to be locked with the locking groove by moving forward of the stopper.

7. The double locking device of claim 1, further including:
a charging door covering and closing a portion where the inlet cover and the charging inlet are disposed, wherein:
the stopper includes a protruding hook protruding in a moving direction of the stopper,
the charging door includes a fixing lock having a fixing groove formed at a side thereof, and
the protruding hook is configured to be locked with the fixing groove by the moving forward of the stopper.
